(19) United States
(12) Patent Application Publication
(10) Pub. No.: US 2025/0233250 A1
(43) Pub. Date: Jul. 17, 2025

(54) Battery System for Electric Vehicle

(71) Applicants: Hyundai Motor Company, Seoul (KR); Kia Corporation, Seoul (KR)

(72) Inventors: Gyung Hoon Shin, Seoul (KR); Chan Sol Kim, Seoul (KR); Jong Gyu Park, Hwaseong-si (KR)

(21) Appl. No.: 18/664,232

(22) Filed: May 14, 2024

(30) Foreign Application Priority Data
Jan. 16, 2024 (KR) 10-2024-0006466

(51) Int. Cl. H01M 50/249; H01M 50/258; H01M 50/296; H01M 50/503; H01M 50/505; H01M 50/583

(52) U.S. Cl. CPC H01M 50/249; H01M 50/258; H01M 50/296; H01M 50/503; H01M 50/505; H01M 50/583

(57) ABSTRACT

A battery system for an electric vehicle provides an interface connecting a vehicle and a battery to enable quick and easy battery replacement. The battery system for an electric vehicle includes: at least one battery pack detachably mounted to a chassis frame; and a battery connector that is arranged on the battery pack and to which a vehicle connector is connected in a direction of attachment and detachment of the battery pack to and from the chassis frame.

### CROSS-REFERENCE TO RELATED APPLICATION(S)

This application is based on and claims priority under 35 U.S.C. § 119 to Korean Patent Application No. 10-2024-0006466, filed on Jan. 16, 2024, in the Korean Intellectual Property Office, the disclosure of which is herein incorporated by reference in its entirety.

### TECHNICAL FIELD

The present disclosure provides a battery system for an electric vehicle, wherein an interface connecting a vehicle and a battery is improved to enable quick and easy battery replacement, and the arrangement structure of the components constituting the battery system is optimized to make it possible to respond to changes in electrical energy demand while maintaining the length of a battery pack in the overall-width direction.

### BACKGROUND

Conventional electric vehicles have a structure that makes it difficult to attach/detach a battery system, resulting in inefficiency in terms of fuel economy when traveling both short and long distances.

For example, a vehicle that mainly travels short distances is disadvantageous in terms of vehicle fuel economy because the vehicle must always travel with a high-energy and heavy battery installed in the vehicle in preparation for battery energy required for vehicle operation

The foregoing described as the background art is intended merely to aid in the understanding of the background of the present disclosure, and is not intended to mean that the present disclosure falls within the purview of the related art already known to those skilled in the art.

### SUMMARY

The following summary presents a simplified summary of certain features. The summary is not an extensive overview and is not intended to identify key or critical elements.

Systems, apparatuses, and methods are described for a battery system for an electric vehicle. A battery system for an electric vehicle may comprise a battery pack configured to be detachably mounted to a chassis frame; and a battery connector arranged on the battery pack and configured to connect to a vehicle connector in a direction parallel to a direction of attachment and detachment of the battery pack to and from the chassis frame . . . .

Also, or alternatively, a battery system for an electric vehicle may comprise two battery modules, disposed opposite to each other, in a battery pack, in a second direction, wherein each of the two battery modules has multiple stacked cells; two end busbars, each connected to the cells of a corresponding battery module of the two battery modules and positioned directly opposite to each other in the second direction; and a module connection busbar connecting the two end busbars so as to connect outputs of the two battery modules . . . .

These and other features and advantages are described in greater detail below.

### BRIEF DESCRIPTION OF THE DRAWINGS

The above and other aspects, features and advantages of the present disclosure will be more apparent from the following detailed description taken in conjunction with the accompanying drawings, in which:

FIG. 1 illustrates multiple replaceable battery packs mounted on a chassis frame according to the present disclosure;

FIG. 2 illustrates a battery pack according to the present disclosure;

FIG. 3 illustrates the shape of a chassis frame from which a battery pack s detached according to the present disclosure;

FIG. 4 illustrates a plan view of a battery pack according to the present disclosure;

FIG. 5 is a cross-sectional view taken along line A-A in FIG. 1;

FIG. 6 is an enlarged view of connector connection portions illustrated in FIG. 5;

FIG. 7 is an enlarged view of a battery connector mounted to an upper case according to the present disclosure;

FIG. 8 illustrates the connection structure of a busbar according to the present disclosure; and

FIG. 9 illustrates inter-busbars configured to connect outputs of cells and end busbars connected to the cells in the present disclosure.

### DETAILED DESCRIPTION

Hereinafter, embodiments disclosed in the present specification will be described in detail with reference to the accompanying drawings, and the same or similar elements are given the same and similar reference numerals, so duplicate descriptions thereof will be omitted.

The terms “module” and “unit” used for the elements in the following description are given or interchangeably used in consideration of only the ease of writing the specification, and do not have distinct meanings or roles by themselves.

In describing the embodiments disclosed in the present specification, when the detailed description of the relevant known technology is determined to unnecessarily obscure the gist of the present disclosure, the detailed description may be omitted. Furthermore, the accompanying drawings are provided only for easy understanding of the embodiments disclosed in the present specification, and the technical spirit disclosed herein is not limited to the accompanying drawings, and it should be understood that all changes, equivalents, or substitutes thereof are included in the spirit and scope of the present disclosure.

Terms including an ordinal number such as “first”, “second”, or the like may be used to describe various elements, but the elements are not limited to the terms. The above terms are used only for the purpose of distinguishing one element from another element.

In the case where an element is referred to as being “connected” or “coupled” to any other element, it should be understood that another element may be provided therebetween, as well as that the element may be directly connected or coupled to the other element. In contrast, in the case where an element is “directly connected” or “directly coupled” to any other element, it should be understood that no other element is present therebetween.

A singular expression may include a plural expression unless they are definitely different in a context.

As used herein, the expression “include” or “have” are intended to specify the existence of mentioned features, numbers, steps, operations, elements, components, or combinations thereof, and should be construed as not precluding the possible existence or addition of one or more other features, numbers, steps, operations, elements, components, or combinations thereof.

An “upward/downward” direction, “forward/rearward” direction, and “overall-width” direction, as used to describe arrangement or features of an element herein, refer to respective directions relative to a hypothetical or actual vehicle with the element installed therein. Reference to the “upward/downward” direction, the “forward/rearward” direction, and the “overall-width direction do not imply or require that the element being described is necessarily installed in the vehicle, or that a vehicle exists. For example, a first direction of an element may be a direction configured to be parallel to the forward/rearward direction of the vehicle if the element is installed in the vehicle and/or mounted in the chassis installed in the vehicle. A second direction of the element may be a direction perpendicular to the first direction and/or configured to be parallel to the overall-width direction of the vehicle if the element is installed in the vehicle and/or mounted in the chassis installed in the vehicle. A third direction of the element may be a direction perpendicular to the first direction and to the second direction and configured to be parallel to the upward and/or downward direction of the vehicle if the element is installed in the vehicle and/or mounted in the chassis installed in the vehicle. An “longitudinal direction” of an element may refer to a direction of a length or longest dimension of the element.

Hereinafter, exemplary embodiments of the present disclosure will be described in detail with reference to the accompanying drawings.

To solve problems as discussed in the background, for example, and others in the art, a structure that allows multiple batteries to be attached and detached in a replaceable manner according to a user's driving conditions is being proposed.

In other words, in the case of a vehicle capable of being equipped with three batteries, only one battery may be attached for short-distance traveling, two batteries may be attached for intermediate distance traveling, and all three batteries may be attached for long-distance traveling, thereby increasing efficiency in terms of fuel economy

In a system in which multiple batteries can be replaced and used, it is beneficial/required not only to quickly attach and detach batteries but also to easily perform the battery attachment and detachment. The present disclosure provides these advantages.

A battery system for an electric vehicle, according to the present disclosure, includes: at least one battery pack 100 detachably mounted to a chassis frame 500; and a battery connector 310 provided in the battery pack 100, and to which a vehicle connector 400 is configured to be connected in a same direction as a direction of attachment and detachment of the battery pack 100 to and from the chassis frame 500.

The battery connector 310 may be mounted on the top surface of the battery pack 100, and the vehicle connector 400 may be positioned at the top of the battery connector 310 so as to be connected to the battery connector 310 in an upward/downward direction (e.g., relative to an orientation of the chassis as it would be installed in a vehicle).

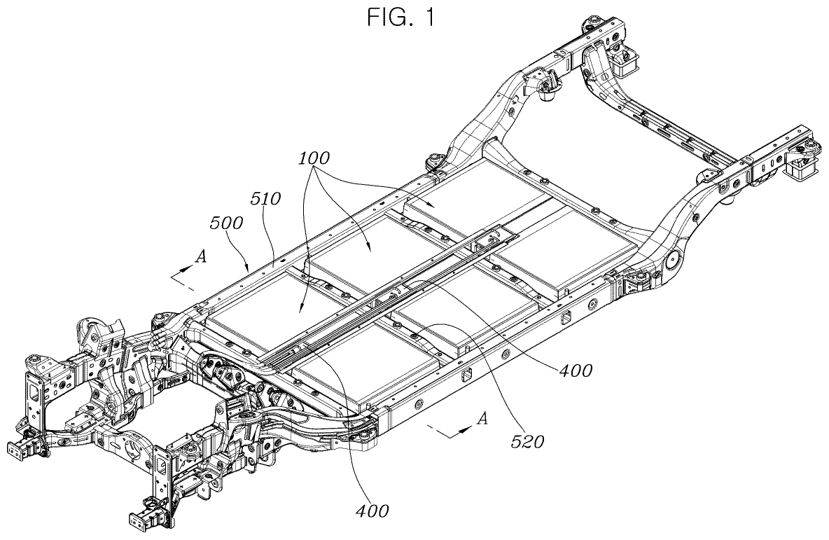

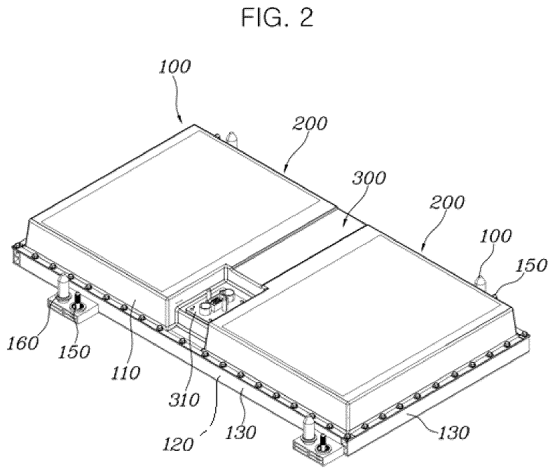

Referring to FIGS. 1 to 3, the battery pack 100 may include left and right battery modules 200 each including multiple cells 210 stacked therein, and an electronic equipment part 300 disposed between the left and right battery modules 200 so as to be configured to manage power and sensing of a battery together with a busbar for power connection between the battery modules 200.

The bottom of the battery pack 100, together with the battery modules 200 and the electronic equipment part 300, may be supported by a lower case 120, and the top of the battery pack 100 may be covered by an upper case 110.

Side members 130 may be fixed to the top surface of the lower case 120 and may be shaped to block the front, rear, left, and right ends of the battery pack 100. The upper case 110 may be fixed to the tops of the side members 130, whereby the battery pack 100 having a sealed structure may be ensured.

The battery pack 100 may be attached or detached to or from the chassis frame 500 constituting a vehicle body.

To this end, side members 510 may be provided on the left and right sides of the vehicle body, and transverse members 520 may be connected to the left and right side members 510 between the left and right side members 510.

The transverse members 520 may be spaced apart at predetermined intervals along the longitudinal direction of the side members 510 (e.g., direction of a longest dimension), and the battery pack 100 may be detachably coupled to a rectangular battery mounting area (a) formed between the side members 510 and the transverse members 520, so that the battery pack 100 may be replaced.

Specifically, alignment parts 160 that serve to align the position of the battery pack 100 may be formed on the side members 130 coupled to the front and rear ends of the battery pack 100 and protrude upward in a pin shape, and pin-shaped fastening parts 150 may be formed to protrude upward beside the alignment parts 160.

Groove-shaped alignment groove parts 540 may be formed on the bottom surfaces of the transverse members 520 so that the alignment parts 160 may be inserted into the alignment groove parts 540 by upward movement, and groove-shaped fastening groove parts 530 may be formed beside the alignment groove parts 540 so that the fastening parts 150 may be placed in the fastening groove parts 530 by upward movement, whereby the battery pack 100 may be attached to the transverse members 520.

In addition, the battery connector 310 may be fixed to the upper case 110 covering the top portion of the battery pack 100.

A connector connection part 430 may be elongated on the top portions of the transverse members 520 in the forward/rearward direction of a vehicle, and the connector connection part 430 may be mounted on the top surface of each of the transverse members 520, and the vehicle connector 400 may be fixed along the longitudinal direction of the connector connection part 430.

Each vehicle connector 400 may be connected to the vehicle by wirings 420 (high-voltage line and low-voltage line) so that electrical energy from the battery pack 100, i.e., high and low voltages, may be provided to the vehicle through the interface between the battery connector 310 and the vehicle connector 400.

In particular, the battery connector 310 may be fixed to the top surface of the battery pack 100, and the vehicle connector 400 may be positioned above the battery connector 310 and connected to the battery connector 310, so that the vehicle connector 400 may be connected to and disconnected from the battery connector 310 in the upward/downward direction of the vehicle.

That is, the conventional battery connector 310 faces a horizontal direction parallel to the forward/rearward direction of the vehicle (e.g., a vehicle when the chassis is included therein), and it may be thus necessary for a worker to do separate work of elevating the vehicle on a hanger in a vehicle production assembly line, and then connecting or disconnecting the battery connector 310 while checking the position of the battery connector 310 below the vehicle.

However, in the present disclosure, the direction of attachment and detachment of the battery pack 100 may be the same as the direction of connection between the vehicle connector 400 and the battery connector 310, and thus the vehicle connector 400 and the battery connector 310 may be automatically connected to each other at the same time as attachment of the battery pack 100, and the vehicle connector 400 and the battery connector 310 may be automatically separated from each other at the same time as detachment of the battery pack.

Therefore, during the attachment or detachment of a battery, the work of connecting or disconnecting the connectors to or from each other may be unnecessary, thereby enabling quick and easy battery attachment/detachment work.

Furthermore, in the present disclosure, the battery modules 200 having the multiple stacked cells 210, and the electronic equipment part 300 may be arranged in the battery pack 100, and division member (e.g., divider) 140 may be provided between each of the battery modules 200 and the electronic equipment part 300 to distinguish areas in which the electronic equipment part 300 and the battery modules 200 may be configured to be and/or may be installed (e.g., the division member 140 may separate a location in which the battery modules 200 is configured to be installed from a location in which the electronic equipment part 300 is configured to be installed). The division member 140 may be arranged in the battery pack 100 in a direction configured to be parallel to a forward/rearward direction of the chassis 500 (e.g., of a vehicle comprising the chassis 500) when the battery pack 100 is installed in the chassis 500.

The electronic equipment part 300 may be disposed in the middle of the battery pack 100, and the battery modules 200 may be disposed on the left and right sides of the electronic equipment part 300.

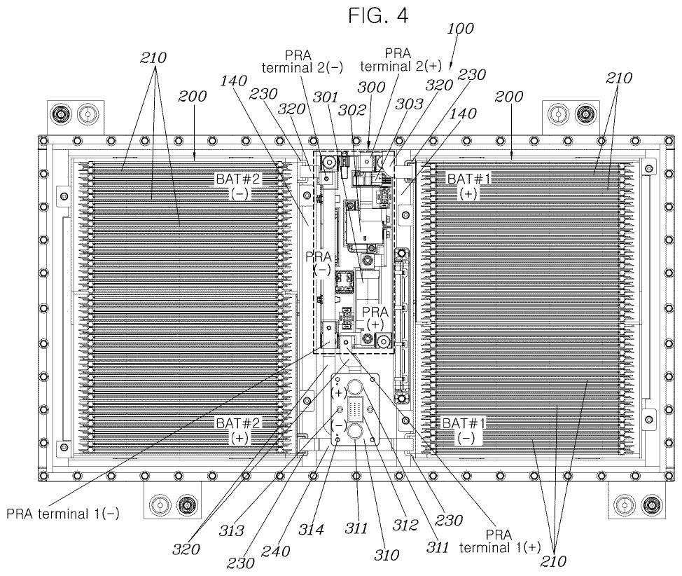

Referring to FIG. 4, an electronic equipment part area for installing the electronic equipment part 300 may be provided in the middle of the inside of the battery pack 100, and the electronic equipment part 300 may be installed in the electronic equipment part area. The electronic equipment part 300 may be a power relay assembly (PRA) with which a battery fuse 301 is integrated. Alternatively, the electronic equipment part 300 may be another electronic equipment component.

The division members (e.g., dividers 140) may be arranged in a front-to-back longitudinal direction on the left and right sides of the electronic equipment part area, so that module areas may be arranged on the left and right sides of the electronic equipment part area, and the battery modules 200, each including the multiple stacked cells 210, may be installed in the respective module areas.

In addition, the cells 210 may be disposed such that the longitudinal direction of the cell 210 is the same direction as the overall-width direction of the vehicle, and thus the cell 210 may be stacked in the forward/rearward direction of the vehicle.

That is, depending on the characteristics of the vehicle, there may be greater restrictions on the overall-width direction of the vehicle compared to the forward/rearward direction of the vehicle, which is the overall-length direction of the vehicle, and thus the battery is also subject to great restriction in the overall-width direction.

Accordingly, when the cells 210 may be disposed such that the longitudinal direction of the cells 210 is the same as the forward/rearward direction of the vehicle, adding the cells 210 to the battery modules 200 may increase the length of the battery modules 200 in the overall-width direction, making it impossible and/or difficult to add the cells 210.

However, in the present disclosure, the cells 210 may be disposed such that the longitudinal direction of the cells 210 is the same as the overall-width direction. Thus, even when the cells 210 are added according to the characteristics of the vehicle and the battery system, it may be possible to proactively respond to the need for increased electrical energy while maintaining the length of the battery in the overall-width direction.

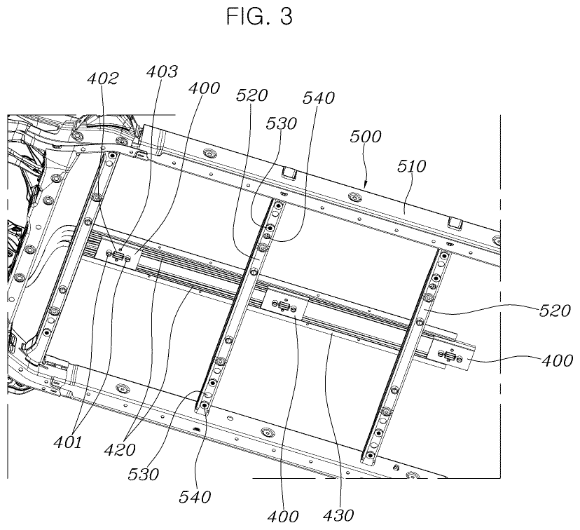

In the present disclosure, a high voltage terminal (e.g., multiple high-voltage terminals 311, as in FIG. 3) and a low-voltage terminal 312 may be arranged on the battery connector 310 in the forward/rearward direction of the vehicle.

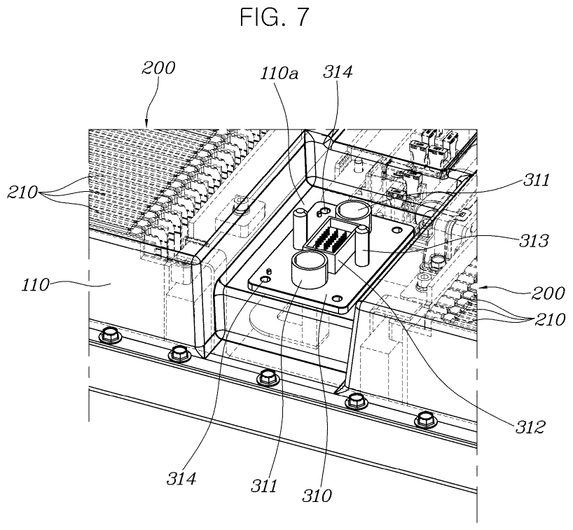

Referring to FIGS. 4 and 7, the low-voltage terminal 312 may be disposed at the center of the battery connector 310, and a (+) high-voltage terminal 311 and a (−) high-voltage terminal 311 may be disposed in front of and behind the low-voltage terminal 312, respectively.

That is, as described above, the cells 210 may be disposed such that the longitudinal direction of the cells 210 is the same as the overall-width direction of the battery pack 100, and thus the space in the middle portion of the battery pack 100 becomes relatively narrow.

Therefore, by arranging the (+) high-voltage terminal 311, the low-voltage terminal 312, and the (−) high-voltage terminal 311 in a row along the forward/rearward direction of the battery pack 100, the overall-width direction of the battery connector 310 may be reduced and/or minimized, and thus the battery connector 310 may be installed without being limited by the overall-width length of the battery pack 100.

For reference, the vehicle connector 400 may have a high-voltage terminal (e.g., high voltage terminals 401) and a low-voltage terminal 402 disposed at locations corresponding to the high-voltage terminal (e.g., high voltage terminals 311) and the low-voltage terminal 312 disposed on the battery connector 310, so that the vehicle connector 400 and the battery connector 310 may be electrically connected to each other.

Furthermore, if the (+) high-voltage terminal 311 and the (−) high-voltage terminal 311 may be arranged in a row along the forward/rearward direction of the battery pack 100, the electrical connection flow is high-voltage terminal(+)→PRA(+)→BAT #1 (+)→BAT #1 (−)→BAT #2 (+)→BAT #2(−)→PRA(−)→high-voltage terminal (−). For reference, the battery fuse 301 may be included in a PRA (+) section.

Improving/optimizing a busbar path to be a shorter/shortest path may reduce/minimize the package size of a battery system and increase/maximize competitiveness in weight/volume energy density.

In addition, the battery connector 310 may be mounted to the battery pack 100 by mounting members 314 (e.g., a mount, a screw, pin, adhesive, weld, etc.), the battery connector 310 and the vehicle connector 400 may have guide pins 313 and a guide hole 403 formed to align relative positions thereof, respectively, and the guide pins 313 and the guide hole 403 may be formed in positions that avoid the mounting members 314.

Referring to FIGS. 4 and 7, the mounting members 314 may be coupled to corner portions of the battery connector 310 and mounted on the battery pack 100.

The guide pins 313 protrude upward from the left and right sides of the battery connector 310, and guide grooves may be formed in the left and right sides of the vehicle connector 400. Thus, when the guide pins 313 are inserted into the guide grooves, the relative positions of the vehicle connector 400 and the battery connector 310 may be aligned, making it easier and simpler to connect the vehicle connector 400 and the battery connector 310 to each other.

In particular, the mounting members 314 may be mounted on the corner portions of the battery connector 310, and the high-voltage terminals 311 and the low-voltage terminal 312 may be disposed on the center portion of the battery connector 310, whereby dead spaces may be formed on the left and right sides of the battery connector 310.

Accordingly, by disposing the guide pin 313 within a dead space that avoids the mounting member 314 and terminal parts, package space required for the configuration of the battery connector 310 and the vehicle connector 400 may be reduced, thereby reducing and/or minimizing the size of the connectors.

In the present disclosure, a mounting groove 110a having a downwardly recessed shape may be formed on the top surface of the battery pack 100, so that the battery connector 310 may be mounted in the mounting groove 110a, and the top of the vehicle connector 400 may be positioned at a height equal to or lower than that of the top of the battery pack 100.

The upper case 110 may cover the top of the battery pack 100, and the mounting groove 110a may be formed on the upper case 110.

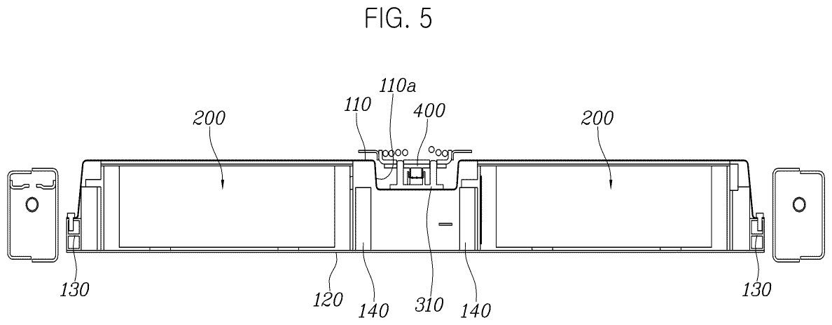

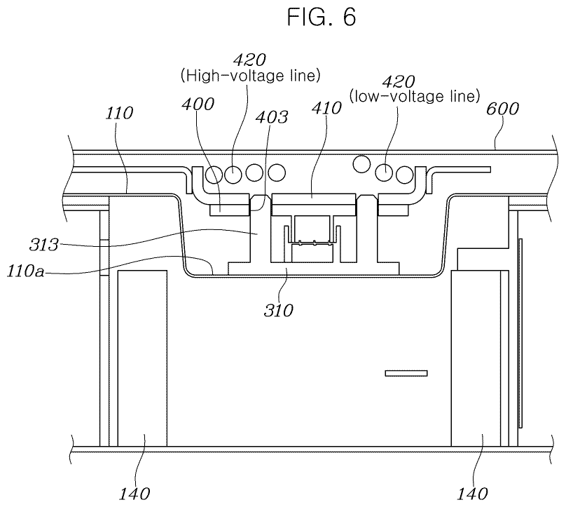

Referring to FIGS. 5 to 7, the mounting groove 110a may be formed in the central front side of the upper case 110 and formed in the shape of a groove having open upper and front ends, the battery connector 310 may be mounted on the bottom surface of the mounting groove 110a, and the vehicle connector 400 may be connected to the top surface of the battery connector 310.

In this case, the top of the vehicle connector 400 may be configured to be positioned at the same height as the top surface of the upper case 110, or may be configured to be positioned at a lower height than the top surface of the upper case 110.

Thus, the protrusion of high-voltage and low-voltage wirings 420 above the upper case 110 may be reduced/minimized. For reference, a floor 600 of the vehicle body may be installed above the battery pack 100 to separate the battery system from a vehicle interior, thereby ensuring the marketability of the vehicle.

In addition, in the present disclosure, a fixed frame 410 having an open top may be fixed to the top surface of the vehicle connector 400, and the wirings 420 configured to connect the vehicle connector 400 to the vehicle may be positioned in the fixed frame 410.

For example, the fixed frame 410 may be formed in the shape of a “U” cross-section having open front and rear ends.

The wirings 420 may be configured to connect the vehicle connector 400 to the vehicle, such that two high-voltage line wirings 420 and one low-voltage line wiring 420 may be positioned in the fixed frame 410.

Thus, there may be no interference with the wirings 420 from the vehicle body, and the wirings 420 may be safely protected.

In the present disclosure, the battery connector 310 and the electronic equipment part 300 may be disposed in the middle of the battery pack 100 in the forward/rearward direction of the vehicle.

Referring to FIGS. 4 and 7, in the middle of the battery pack 100, the battery connector 310 may be disposed in the front and the PRA may be disposed in the rear.

That is, the cells 210 constituting the battery modules 200 on the left and right sides of the battery pack 100 may be disposed such that the longitudinal direction of the cells 210 may be the same as the overall-width direction of the battery pack 100, and thus the space in the middle portion of the battery pack 100 becomes relatively narrow.

Therefore, by disposing the battery connector 310 and the PRA in the front and the rear in the middle of the battery pack 100, the overall-width direction of the battery connector 310 may be reduced/minimized. Thus, the battery connector 310 and the PRA may be installed without being limited by the length of the battery pack 100 in the overall-width direction.

Furthermore, in the present disclosure, the left and right battery modules 200 may be connected to each other by a module connection busbar 240, the module connection busbar 240 may be shaped to avoid the battery connector 310 and may be connected to the left and right battery modules 200, and the electronic equipment part 300 may be connected to the battery connector 310 and the left and right battery modules 200 by electronic equipment connection busbars 320.

The lower case 120 may be supported by the bottom of the battery pack 100, the module connection busbar 240 may be shaped to be bent and extend from a portion bent toward the lower case 120 to a portion formed along the bottom surface of the lower case 120, and a space may be formed at the top of the module connection busbar 240 so that the battery connector 310 may be placed in the space.

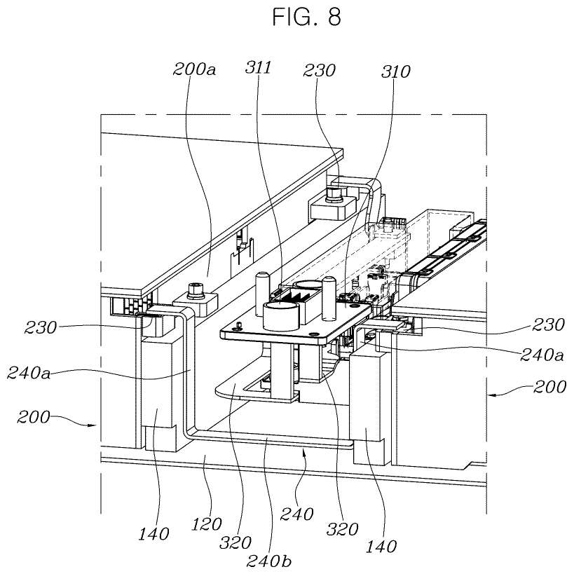

Referring to FIGS. 7 and 8, the module connection busbar 240 may be formed in a U-shape, both ends thereof may be electrically connected to the left and right battery modules 200, respectively, and a horizontally formed middle portion thereof may be positioned above and adjacent and parallel to the bottom surface of the lower case 120.

Accordingly, by forming a space at the top of the module connection busbar 240 and installing the battery connector 310 in the space, the module connection busbar 240 may be optimally disposed in a space below the battery connector 310.

In addition, the electronic equipment connection busbars 320 may be electrically connected to the battery connector 310, and may be electrically connected to the left and right battery modules 200, respectively. Electronic equipment components may be connected to the electronic equipment connection busbar 320.

In particular, a space may be provided between the battery connector 310 and the module connection busbar 240 such that the electronic equipment connection busbar 320, which may be connected to the left battery module 200, and the electronic equipment connection busbar 320, which may be connected to the right battery modules 200, can be connected to the (+) high-voltage terminal 311 and (−) high-voltage terminal 311 of the battery connector 310.

Therefore, the space provided below the battery connector 310 may be used to optimize and simplify the connection paths of the module connection busbar 240 and the electronic equipment connection busbars 320 so that the module connection busbar 240 and the electronic equipment connection busbars 320 can be safely isolated from high-voltage surrounding components.

The configuration of a battery system for an electric vehicle, according to the present disclosure, may also be expressed as follows.

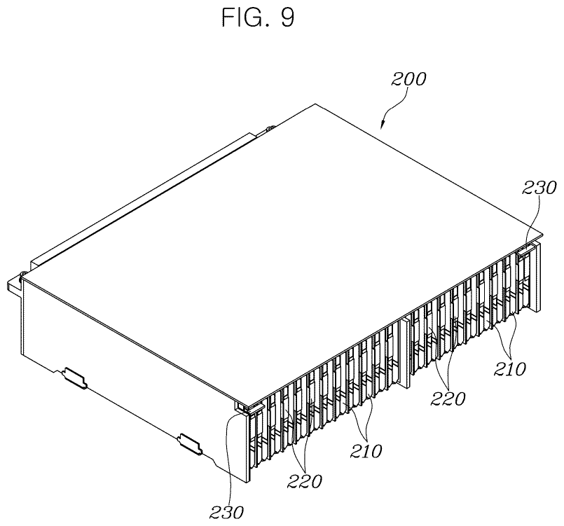

Referring to FIGS. 4 and 9, a battery pack 100 includes: multiple battery modules 200 having multiple stacked cells 210 and disposed opposite to each other in the battery pack 100; end busbars 230 connected to the cells 210 of each of the battery modules 200 and connected in opposite positions with the shortest distance between the battery modules 200; and a module connection busbar 240 connected between a pair of opposite end busbars 230 so as to connect outputs of the battery modules 200.

Specifically, ends of the cells 210 stacked in the left battery module 200 and ends of the cells 210 stacked in the right battery modules 200 may be disposed opposite to each other.

The end busbars 230 may be connected to ends of specific cells 210 among the oppositely disposed cells 210, so that the end busbars 230 of the left and right battery modules 200 may be opposite to each other, and both ends of the module connection busbar 240 may be connected to the pair of opposite end busbars 230 between the pair of opposite end busbars 230.

The module connection busbar 240 serves to connect outputs between the battery modules 200.

Thus, the module connection busbar 240 that connects the outputs of the left and right battery modules 200 may be connected with the shortest distance, thereby reducing/minimizing the package size of the battery system and ensuring competitiveness in weight/volume energy density.

The cells 210 may be disposed such that the longitudinal direction of the cells 210 may be the same as the overall-width direction of the vehicle, and the cells 210 may thus be stacked in the forward/rearward direction of the vehicle. Inter-busbars 220 may be connected to ends of the stacked cells 210 so as to connect outputs of the cells 210. The end busbars 230 may be connected to cells 210 stacked at the outermost edge of each battery module 200.

FIG. 9 illustrates the battery modules 200 from which a module housing 200a covering the inter-busbars 220 on the side surface of the battery modules 200 may be detached. For example, at the left end of the cells 210, two cells 210 may be connected to each other by an inter-busbar 220, and one of the two cells 210 connected at the left end may be connected to another neighboring cell 210 at the right end by an inter-busbar 220, so that the cells 210 may be continuously connected, thereby connecting the outputs of the cells 210.

The end busbars 230 may be connected to the ends of the cells 210 stacked at foremost and rearmost sides of the battery modules 200, respectively, so that the front end busbars 230 and the rear end busbars 230 function as (+) terminals and (−) terminals of the battery modules 200, respectively.

That is, busbars may be arranged at the front and rear ends of the left and right battery modules 200 so as to serve to connect the outputs of the battery modules 200. Thus, the connection paths of the busbars may be designed to be optimized so that the busbars do not interfere with the battery connector 310, including the electronic equipment part 300 provided in the battery pack 100.

Furthermore, in the present disclosure, a battery connector 310 connected to a vehicle connector 400 may be disposed between the battery modules 200, and the module connection busbar 240 may be shaped to avoid the battery connector 310 and directly connected between the end busbars 230.

A lower case 120 may be supported by the bottom of the battery pack 100. The module connection busbar 240 may be shaped such that first portions 240a bent from both ends thereof connected to the end busbars 230 toward the lower case 120 may be connected to a second portion 240b bent along the bottom surface of the lower case 120 from the bottoms of the first portions 240a. The battery connector 310 may be placed in the space formed between the first portions 240a and the second portion 240b.

Referring to FIGS. 7 and 8, an end busbar 230 may be connected to a (−) output portion formed on a foremost cell 210 of the left battery module 200, and a left end of the module connection busbar 240 may be connected to the end busbar 230, and a left first portion 240a may be vertically bent downward from the left end toward the lower case 120.

An end busbar 230 may be connected to a (+) output portion formed on a foremost cell 210 of the right battery module 200, a right end of the module connection busbar 240 may be connected to the end busbar 230, and a right first portion 240a may be vertically bent downward from the right end of the module connection busbar 240 toward the lower case 120.

Accordingly, a second portion 240b may be connected to the bottom of the left first portion 240a and the bottom of the right first portion 240a between the left first portion 240a and the right first portion 240a, wherein the second portion 240b may be disposed adjacent to and parallel to the bottom surface of the lower case 120.

That is, the module connection busbar 240 may be formed in a U-shape by the first portions 240a and the second portion 240b, and thus a space may be formed at the top of the second portion 240b, and the battery connector 310 may be installed at the upper portion of the space, and thus the module connection busbar 240 may be optimally disposed in the space below the battery connector 310.

Therefore, in the space provided below the battery connector 310, the module connection busbar 240 may be disposed with the shortest path while avoiding the battery connector 310, thereby optimizing the connection path of the module connection busbar 240 to enable the module connection busbar 240 to be safely isolated from high-voltage surrounding components.

Furthermore, in the present disclosure, an electronic equipment part area may be provided between the battery modules 200, and in the electronic equipment part area, the electronic equipment part 300 may be electrically connected to the battery connector 310 by the electronic equipment connection busbars 320, and electrically connected to a pair of other opposite end busbars 230 between the other opposite end busbars 230.

The electronic equipment part area and a connector area in which the battery connector 310 may be disposed may each be disposed along a straight section between the battery modules 200.

Referring to FIG. 4, a connector area may be provided in front between the left and right battery modules 200, so that the battery connector 310 may be disposed in the connector area, and an electronic equipment part area may be provided in the rear of the connector area, so that the electronic equipment part 300 may be disposed in the electronic equipment part area.

In particular, another end busbar 230 may be connected to a (+) output portion formed in a rearmost cell 210 of the left battery module 200, a (+) line of the electronic equipment part 300 may be connected to the other end busbar 230 in the forward/rearward direction by an electronic equipment connection busbar 320, and the (+) line of the electronic equipment part 300 may be connected to a (+) high-voltage terminal 311 of the battery connector 310.

Another end busbar 230 may be connected to a (−) output portion formed in a rearmost cell 210 of the right battery module 200, a (−) line of the electronic equipment part 300 may be connected to the other end busbar 230 in the forward/rearward direction by an electronic equipment connection busbar 320, and the (−) line of the electronic equipment part 300 may be connected to a (−) high-voltage terminal 311 of the battery connector 310.

That is, the detailed electrical connection order is described as being high-voltage terminal (+)→PRA terminal 1(+)→a fuse→relay 302→a current sensor 303→PRA terminal 2 (+)→BAT #1 (+)→BAT #1 (−)→BAT #2 (+)→BAT #2 (−)→PRA terminal 2 (−)→PRA terminal 1 (−)→Connector (−).

The battery fuse 301, which corresponds to the electronic equipment part 300 component (electronic equipment component), may serve to block a high voltage, the relay 302 may serve to turn a high-voltage connection on and/or off, and/or the current sensor 303 may serve to measure a current in a series high-voltage connection of the battery system.

In this case, the electronic equipment part 300 component may be configured on the (+) line of the electronic equipment part 300 to optimize the package layout, but may also be configured on the (−) line of the electronic equipment part 300.

As described above, in the present disclosure, the vehicle connector 400 and the battery connector 310 may be automatically connected or disconnected to or from each other at the same time as the battery pack 100 may be attached or detached. Therefore, during the attachment or detachment of a battery, the work of connecting or disconnecting the connectors to or from each other may be unnecessary, thereby enabling quick and easy battery attachment/detachment work.

Furthermore, the cells 210 may be disposed such that the longitudinal direction of the cells 210 is the same as the overall-width direction, thereby making it possible to proactively respond to the need for increased electrical energy while maintaining the length of the battery in the overall-width direction when adding cells 210 according to the characteristics of the vehicle and the battery system.

An aspect of the present disclosure is to provide a battery system for an electric vehicle, wherein an interface connecting the vehicle and a battery is improved to enable quick and easy battery replacement, and the arrangement structure of components constituting the battery system is optimized to make it possible to respond to changes in electrical energy demand while maintaining the length of a battery pack in the overall-width direction.

In view of the foregoing, a configuration of the present disclosure includes: at least one battery pack detachably mounted to a chassis frame; and a battery connector which is arranged on the battery pack and to which a vehicle connector is connected in the same direction as a direction of attachment and detachment of the battery pack to and from the chassis frame.

The battery connector may be mounted on a top surface of the battery pack, and the vehicle connector may be positioned above the battery connector and connected to the battery connector in an upward/downward direction.

Battery modules, each having multiple stacked cells, and an electronic equipment part may be arranged in the battery pack, and division members may be arranged between the battery modules and the electronic equipment part in a forward/rearward direction of a vehicle to distinguish areas in which the electronic equipment part and the battery modules are installed.

The electronic equipment part may be disposed in the middle of the battery pack, and the battery modules may be disposed at left and right sides of the electronic equipment part.

The cells may be disposed such that a longitudinal direction of each of the cells is the same as an overall-width direction of the vehicle, and the cells may be stacked in the forward/rearward direction of the vehicle.

Multiple high-voltage terminals and a low-voltage terminal are arranged on the battery connector in the forward/rearward direction of the vehicle.

The battery connector may be mounted to the battery pack by a mounting member, the battery connector and the vehicle connector may be configured to have a guide pin and a guide hole, respectively, which are configured to align relative positions of the battery connector and the vehicle connector, and the guide pin and the guide hole may be formed in positions in which the mounting member is avoided.

A mounting groove having a downwardly recessed shape is formed on a top surface of the battery pack, so that the battery connector is mounted in the mounting groove, and a top of the vehicle connector may be positioned at a height equal to or lower than that of a top of the battery pack.

The top of the battery pack may be covered by an upper case, and a mounting groove may be formed on the upper case.

A fixed frame having an open top may be fixed to a top surface of the vehicle connector, and a wiring configured to connect the vehicle to the vehicle connector may be positioned in the fixed frame.

The battery connector and the electronic equipment part may be disposed in the middle of the battery pack in the forward/rearward direction of the vehicle.

The left and right battery modules may be connected to each other by a module connection busbar, the module connection busbar may be shaped to avoid the battery connector and connected to the left and right battery modules, and the electronic equipment part may be connected to the battery connector and the left and right battery modules by an electronic equipment connection busbar.

A lower case may be supported by a bottom of the battery pack, the module connection busbar may be shaped to be bent and extend from a portion bent toward the lower case to a portion formed along a bottom surface of the lower case, and a space may be formed at the top of the module connection busbar so that the battery connector is placed in the space.

Another configuration of a battery system for an electric vehicle, according to the present disclosure, may include: multiple battery modules, each of which has multiple stacked cells, disposed opposite to each other in a battery pack; end busbars connected to the cells of each battery module and connected to at opposite positions with a shortest distance between the battery modules; and a module connection busbar connected between a pair of opposite end busbars so as to connect outputs of the battery modules.

The cells may be disposed such that a longitudinal direction of each of the cells is the same as an overall-width direction of the vehicle, and the cells may be stacked in a forward/rearward direction of the vehicle, inter-busbars may be connected to ends of the stacked cells so as to connect outputs of the cells, and the end busbars may be connected to cells stacked at the outermost edge of each battery module.

A battery connector may be disposed between the battery module and connected to a vehicle connector, and the module connection busbar may be shaped to avoid the battery connector and directly connected to the end busbars.

A lower case may be supported by a bottom of the battery pack, the module connection busbar may be formed in a shape in which first portions bent toward the lower case from both ends of the module connection busbar connected to the end busbars are connected to a second portion bent from bottoms of the first portions along a bottom surface of the lower case, and the battery connector may be placed in a space formed between the first portions and the second portion.

An electronic equipment part area may be arranged between the battery modules, and in the electronic equipment part area, an electronic equipment part may be electrically connected to the battery connector by an electronic equipment connection busbar and may be electrically connected to a pair of other opposite end busbars.

The electronic equipment part area and a connector area in which the battery connector is disposed may each be disposed along a straight section between the battery modules.

The electronic equipment part may be an electronic equipment component in which a PRA is integrated with a fuse.

With the above solutions of the present disclosure, the vehicle connector and the battery connector are automatically connected or disconnected at the same time as a battery pack is attached or detached. Therefore, during the attachment or detachment of the battery, the work of connecting or disconnecting the connectors to or from each other is unnecessary, thereby enabling quick and easy battery attachment/detachment work.

Furthermore, the cells may be disposed such that the longitudinal direction of the cells is the same as the overall-width direction, thereby making it possible to proactively respond to the need for increased electrical energy while maintaining the length of the battery in the overall-width direction when adding cells according to the characteristics of the vehicle and the battery system.

Although the present disclosure has been described and illustrated in conjunction with the above particular embodiments thereof, it will be apparent to those skilled in the art that various changes and modifications may be made to the present disclosure without departing from the technical idea of the present disclosure, and these changes and modifications fall within the scope of the appended claims.

What is claimed is:

1. A battery system for an electric vehicle, the battery system comprising:
a battery pack configured to be detachably mounted to a chassis frame; and
a battery connector arranged on the battery pack and configured to connect to a vehicle connector in a direction parallel to a direction of attachment and detachment of the battery pack to and from the chassis frame.

2. The battery system of claim 1, wherein:
the battery connector is mounted on a top surface of the battery pack; and
the vehicle connector is configured to:
be positioned above the battery connector, and
connect or disconnect to the battery connector in an upward/downward direction.

3. The battery system of claim 1, wherein the battery pack comprises: two battery modules, each comprising multiple stacked cells;
an electronic equipment part arranged in the battery pack; and
division members arranged in a first direction, wherein the first direction is configured to be parallel to a forward/rearward direction of a vehicle comprising the chassis frame if the battery pack is mounted in the chassis frame, wherein the division members are arranged to distinguish:
a first area in which the electronic equipment part is installed,
a second area, to a first side of the first area in the first direction, in which a first battery module of the two battery modules is installed, and
a third area, to a second side of the first area opposite the first side, in which a second battery module of the two battery modules is installed.

4. The battery system of claim 3, wherein the first battery module of the two battery modules is disposed on a first side of the electronic equipment part, and the second battery module of the two battery modules is disposed on a second side of the electronic equipment part opposite to the first side.

5. The battery system of claim 3, wherein the multiple stacked cells are stacked in the first direction such that a longitudinal direction of each cell of the multiple stacked cells is parallel to a second direction that is perpendicular to the first direction and configured to be parallel to an overall-width direction of the vehicle comprising the chassis frame if the battery pack is mounted in the chassis frame.

6. The battery system of claim 1, wherein multiple high-voltage terminals and a low-voltage terminal are arranged on the battery connector in a first direction, wherein the first direction is configured to be parallel to a forward/rearward direction of a vehicle comprising the chassis frame if the battery pack is mounted in the chassis frame.

7. The battery system of claim 5, wherein:
the battery connector is mounted to the battery pack by a mounting member; and
the battery connector comprises a guide pin and the vehicle connector forms a guide hole, wherein the guide pin and the guide hole are positioned to:
align the battery connector with the vehicle connector, and
avoid the mounting member.

8. The battery system of claim 5, wherein:
the battery connector is mounted in a mounting groove formed on a first surface of the battery pack, wherein the first surface faces a third direction that is configured to be parallel to an upward direction of the vehicle comprising the chassis frame if the battery pack is mounted in the chassis frame; and
the vehicle connector extends in the third direction to a position equal to or less than a position to which the first surface of the battery pack extends in the third direction.

9. The battery system of claim 8, wherein:
the first surface of the battery pack is formed by an upper case of the battery pack; and
the mounting groove is formed in the upper case.

10. The battery system of claim 8, wherein:
a fixed frame having an opening in the third direction is fixed to a surface of the vehicle connector in the third direction; and
a wiring configured to connect the vehicle to the vehicle connector is positioned in the fixed frame.

11. The battery system of claim 3, wherein the battery connector and the electronic equipment part are disposed in the middle of the battery pack in the first direction.

12. The battery system of claim 11, wherein:
the first battery module and the second battery module are connected to each other by a module connection busbar;
wherein the module connection busbar is shaped to avoid the battery connector and connected to the first battery module and the second battery module; and
the electronic equipment part is connected, via an electronic equipment connection busbar, to the battery connector, the first battery module, and the second battery module.

13. The battery system of claim 12, further comprising
a lower case supported by a surface of the battery pack facing a fourth direction that is configured to be parallel to a downward direction of the vehicle comprising the chassis frame if the battery pack is mounted in the chassis frame, wherein:
the module connection busbar comprises a bent portion and extends from the bent portion toward the lower case to a portion formed along a surface of the lower case facing opposite to the fourth direction; and
the battery connector is positioned in a space formed by the bent portion of the module connection busbar.

14. A battery system for an electric vehicle, the battery system comprising:
two battery modules, disposed opposite to each other, in a battery pack, in a second direction, wherein each of the two battery modules has multiple stacked cells;
two end busbars, each connected to the cells of a corresponding battery module of the two battery modules and positioned directly opposite to each other in the second direction; and
a module connection busbar connecting the two end busbars so as to connect outputs of the two battery modules.

15. The battery system of claim 14, further comprising inter-busbars connecting ends of the stacked cells so as to connect outputs of the cells, wherein:
the cells are disposed such that a longitudinal direction of each of the cells is parallel to the second direction, and the cells are stacked in a first direction perpendicular to the second direction; and
the two end busbars are directly connected to opposing cells stacked at the outermost edge of the corresponding battery modules.

16. The battery system of claim 14, wherein:
a battery connector is disposed between the two battery modules and connected to a vehicle connector; and
the module connection busbar is shaped to avoid the battery connector and is directly connected to the end busbars.

17. The battery system of claim 16, further comprising a lower case supported at a surface of the battery pack facing a third direction perpendicular to the second direction and to a first direction in which the cells are stacked; wherein:
the module connection busbar comprises first portions that bend from connections to the two end busbars toward the lower case to a second portion that extends along a surface of the lower case; and
the battery connector is placed in a space formed between the first portions and the second portion.

18. The battery system of claim 16, further comprising:
an electronic equipment part arranged between the battery modules;
an electronic equipment connection busbar connecting the electronic equipment part to the battery connector; and
two other end busbars positioned directly opposite to each other in the second direction, wherein the electronic equipment part is electrically connected to the two other end busbars.

19. The battery system of claim 18, wherein the electronic equipment part and the battery connector are each disposed along a straight section between the battery modules.

20. The battery system of claim 18, wherein the electronic equipment part comprises a power relay assembly integrated with a fusc.
